(19) United States
(12) Patent Application Publication
(10) Pub. No.: US 2012/0106325 A1
(43) Pub. Date: May 3, 2012

(54) Adaptive Shaper for Reliable Multicast Delivery over Mixed Networks

(76) Inventor: Ramsundar Janakiraman, Sunnyvale, CA (US)

(21) Appl. No.: 12/916,230

(22) Filed: Oct. 29, 2010

(51) Int. Cl. H04L 12/26

(52) U.S. Cl. 370/230

(57) ABSTRACT

Improved handling of multicast streams in digital networks. A switching device in a digital network such as a controller, bridge, or access point examines streams flowing through the device. The device identifies a multicast stream and assigns a stateful session to this stream. QoS marking may be applied to the stream. The device assigns a shaping policy to the stream, assigning it a default value in terms of bandwidth credits. This default value may be dependent on the stream type. The credits used by the stream are evaluated periodically. If the stream has exceeded the allocated bandwidth for the shaping policy, the number of credits are increased by a predetermined factor. If the stream has unused credits, the allocated number of credits are reduced by a predetermined factor. The increase and decrease factors may be tuned, for example, to provide a fast attack and a slow decay. The period used for stream evaluation may be adjusted. Increasing the period decreases the load on the device CPU; decreasing the period allows for better convergence at a cost of more load on the CPU. This approach allows the packets in the stream to be released at a constant rate and allows transmission of bursty traffic over networks on which congestion conditions can change rapidly such as wireless and vpn tunnels. In addition, the potential for downstream drops due to the lack of buffers in downstream switch/routers due to the burstiness is reduced.

### BACKGROUND OF THE INVENTION

The present invention relates to digital networks, and in particular, to delivering and managing multimedia streams over mixed networks including VPNs and wireless LANs (WLANs).

Digital networks have rapidly become the backbone of many enterprises, small and large. Such networks are used for handling many different kinds of traffic. Multimedia traffic, such as video, presents particular problems in the mixed wired—wireless environment.

Such multimedia traffic is typically transmitted to interested clients in the form of multicast streams. These multicast streams are sent using UDP, a connectionless protocol. UDP is a simple transmission protocol without implicit hand-shaking dialogs for providing reliability, packet ordering, or data integrity. It is understood that UDP provides a service without reliability guarantees, and that datagrams may arrive out of order, appear duplicated, or go missing without notice, assuming that error detection and correction if any is either not necessary or is performed in the client application.

Transmitting multicast streams over a wired network covers a multitude of sins. By the very nature of the wired network, all packets travel at wire speed, and the CSMA/CD nature of wired Ethernet reduces chances of packet loss or collision, particularly when such streams are delivered within an enterprise or campus network with only a few L2 and/or L3 switches.

These wireline speeds, often 100 Mbs or 1 Gbs data rates, encounter severe speed mismatches when certain boundaries are crossed into more limited speed portions of the network. One example is a VPN (Virtual Private Network) bridge, or RAP (remote access point), where traffic for one or more clients is concentrated and sent over a lower bandwidth channel. As examples, a tunnel for a VPN or RAP may deliver streams over the switched Internet and through a cable modem system to a small business or home, with data rates limited to 10 Mbs or lower.

Similar speed mismatch issues exist when multicast streams hit the wireless portion of a network. Multicast streams are transmitted over wireless networks at a slow rate, typically 24 Mbs. This is in stark contrast to the 300 to 600 Mbs data rates possible with 802.11n wireless traffic. As a result, multimedia streams take up a significant amount of airtime because of this slow datarate.

In such cases where multicast streams encounter speed mismatches, because such streams are sent using UDP, unless they are otherwise tagged for special handling they are commonly considered low priority and are high on the list of traffic to be dropped as the channel becomes congested.

Some media servers, producers of multicast streams, exacerbate these issues by generating very bursty multicast traffic, even when configured for CBR (constant bit rate) encoding. While such bursty traffic may average out to low datarates over a period of tens of seconds or more, very bursty traffic can result in drops as these bursts encounter speed mismatches in the network.

What is needed is a way to improve handling of multicast streams over mixed wired and wireless networks.

### BRIEF DESCRIPTION OF THE DRAWINGS

The invention may be best understood by referring to the following description and accompanying drawings that are used to illustrate embodiments of the invention in which:

FIG. 1 shows clients in a network.

### DETAILED DESCRIPTION

Embodiments of the invention relate to methods of improving delivery of multicast streams in mixed wired-wireless digital networks.

According to the present invention, an intelligent device on the network such as a switch, controller, or access point identifies a multicast stream. The device assigns a stateful session to this stream. QoS marking may be applied to the stream. The device assigns a shaping policy to the stream, assigning it a default value in terms of bandwidth credits. This default value may be dependent on the stream type. The credits used by the stream are evaluated periodically. If the stream has exceeded the allocated bandwidth for the shaping policy, the number of credits are increased by a predetermined factor. If the stream has unused credits, the allocated number of credits are reduced by a predetermined factor. The increase and decrease factors may be tuned, for example, to provide a fast attack and a slow decay. The period used for stream evaluation may be adjusted. Increasing the period decreases the load on the device CPU; decreasing the period allows for better convergence at a cost of more load on the CPU.

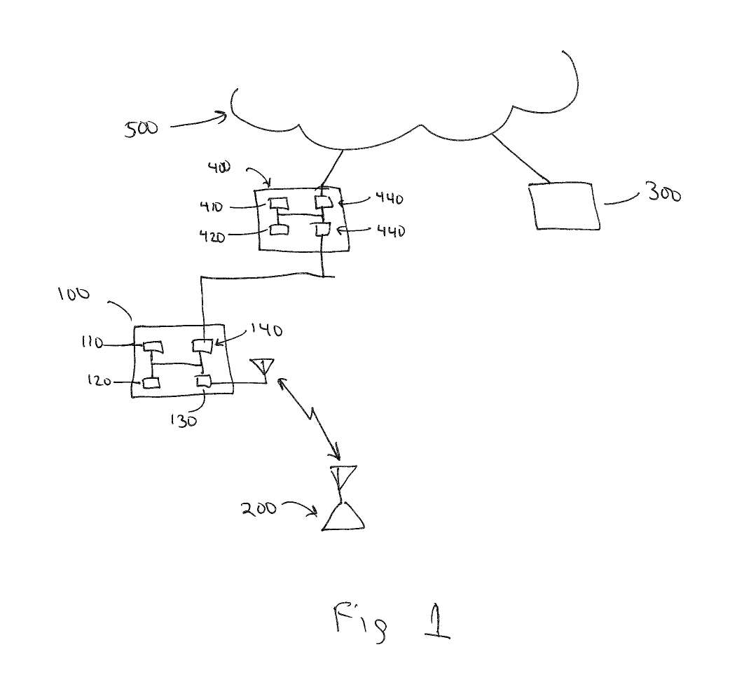

FIG. 1 shows a network in which access points (APs) 100 are purpose-made digital devices, each containing a processor 110, memory hierarchy 120, and input-output interfaces 130. In one embodiment of the invention, a MIPS-class processor such as those from Cavium or RMI is used. Other suitable processors, such as those from Intel or AMD may also be used. The memory hierarchy 120 traditionally comprises fast read/write memory for holding processor data and instructions while operating, and nonvolatile memory such as EEPROM and/or Flash for storing files and system startup information. Wired interfaces 140 are typically IEEE 802.3 Ethernet interfaces, used for wired connections to other network devices such as switches, or to a controller. Wireless interfaces 130 may be WiMAX, 3G, 4G, and/or IEEE 802.11 wireless interfaces. In one embodiment of the invention, APs operate under control of a LINUX operating system, with purpose-built programs providing host controller and access point functionality. Access points 100 typically communicate with a controller 400, which is also a purpose-built digital device having a processor 410, memory hierarchy 420, and commonly a plurality of wired interfaces 440. Access points 100 may also include devices operating as bridges, remote access points, and the like. Controller 400 provides access to network 500, which may be a private intranet or the public internet. Also shown is multimedia server 300 attached to network 500.

Client devices 200 have similar architectures, chiefly differing in input/output devices; a laptop computer will usually contain a large LCD, while a handheld wireless scanner will typically have a much smaller display, but contain a laser barcode scanner.

The present invention deals with multicast streams such as those used to distribute video, audio, or multimedia. Distribution of multicast streams is based on UDP, a connectionless protocol. UDP is a simple transmission protocol, defined in RFC 768, without implicit hand-shaking dialogs for providing reliability, packet ordering, or data integrity. It is understood that UDP provides a service without reliability guarantees, and that datagrams may arrive out of order, appear duplicated, or go missing without notice, assuming that error detection and correction if any is either not necessary or is performed in the client application.

A media server producing and distributing multicast streams to clients may produce bursty traffic which is quite reasonable for high-speed wireline transmission such as over wired gigabit Ethernet, but which causes problems when speed mismatches are encountered such as in wireless LANs (WLANs), VPNs, tunnels, and the like.

As an example, a media server may produce packets of 8K or 16K bytes, which will of necessity result in fragmentation of the packets at the IP transport layer. The degree of fragmentation will be controlled by the smallest MTU (Maximum Transmission Unit) supported through the network path, which may be on the order of 1500 bytes, the maximum typically supported by wired Ethernet at the network layer. If a single packet is dropped, this results in the loss of 8K or 16K bytes of data at the application layer, resulting in unacceptably choppy playback. Even though the multicast data rates may be low when averaged over a period of many milliseconds, the bursty nature of the traffic still causes problems.

According to the present invention, a network device such as a controller, bridge, or access point monitors the traffic it is carrying to detect individual multicast streams and apply shaping policies to each such stream.

According to the invention, when a network device such as a controller, switch, bridge, or AP identifies the first packet in a UDP multicast stream, the device creates a stateful session permitting the traffic. QoS marking may be applied to the stream, or may have been applied by an upstream device.

The device assigns a shaping policy to the session with a predetermined default value. This default value may optionally be determined by the RTP type, or by other indicia of stream contents. As examples, an audio-only stream would be assigned a lower value, while a multimedia stream would be assigned a higher value such as 2 mbps. The shaping policy defines for example the rate at which packets from the stream are released from a buffer pool for transmission, leveling out the transmission rate.

Periodically the amount of credits actually used by the stream is monitored. If the stream has exceeded the allocated bandwidth, its credits for the shaping policy are increased by a predetermined factor such as N. If the stream has unused credits, its credits for the shaping policy are decreased by a predetermined factor such as N/2. The increase and decrease factors may be different, and may be dependent on RTP type or other indicia associated with the individual stream. These factors can be tuned to increase the convergence rate. As a too small credit allocation may mean that packets on the stream are dropped, it is preferred to have a shaping policy which results in a fast attack, slow decay response.

The period at which the stream and its credits for the shaping policy are monitored can be increased to decrease the load on the device CPU. The period may be decreased for faster convergence at a cost of increased load on the device CPU. A too short period may result in oscillation.

In another embodiment, the actual bandwidth consumed for the stream is tracked on a periodic basis, for example a fraction of a second to a second. This record of actual bandwidth consumed is used to increase or decrease allocated bandwidth. Attack and decay factors may be applied to the consumed bandwidth to better support bursty transmissions, which suggest rapid attack and slow decay adjustments to bandwidth allocation.

In an additional embodiment, the credit-based approach may be combined with this usage-based approach to shape the stream.

The present invention also may be embedded in nontransitory fashion in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

I claim:

1. A method handling multicast streams by a digital device in a digital network comprising:
recognizing a multicast stream at the digital device,
assigning a shaping policy to the multicast stream, the shaping policy having one or more measurements and one or more parameters, the measurements being made on a periodic basis and the parameters being adjusted according to the measurements also on the periodic basis, and
applying the shaping policy to the multicast stream, periodically making measurements according to the shaping policy, and adjusting the shaping policy parameters based on the measurements.

2. The method of claim 1 where the device selects a shaping policy from a plurality of shaping policies based on the stream type.

3. The method of claim 1 where the device uses a shaping policy with initial values for shaping policy parameters selected based on the stream type.

4. The method of claim 1 where the shaping policy measures the amount of data consumed by the stream in a given period, and adjusts a parameter for the bandwidth allocated to the stream based on the measured amount of data consumed during the previous period.

5. The method of claim 4 where the shaping policy has parameters for increase and decrease of the bandwidth allocation parameter.

6. The method of claim 5 where the initial bandwidth allocation parameter and the increase and decrease parameters are selected based on stream type.

7. The method of claim 1 where the shaping policy has at least a parameter for bandwidth credits and at least a measurement for credits used, wherein the measured credits used in the previous period are used to adjust the bandwidth credits for the next period.

8. The method of claim 7 where the initial bandwidth credits parameter is selected based on stream type.

9. The method of claim 7 where the shaping policy has parameters for increase and decrease of the bandwidth credits parameter.

10. A machine readable medium having a set of instructions stored in non transitory form therein, which when executed on a network device cause a set of operations to be performed comprising:
recognizing a multicast stream at the network device,
assigning a shaping policy to the multicast stream, the shaping policy having one or more measurements and one or more parameters, the measurements being made on a periodic basis and the parameters being adjusted according to the measurements also on the periodic basis, and
applying the shaping policy to the multicast stream, periodically making measurements according to the shaping policy, and adjusting the shaping policy parameters based on the measurements.
